(19) United States
(12) Patent Application Publication
(10) Pub. No.: US 2009/0074923 A1
(43) Pub. Date: Mar. 19, 2009

(54) System and Method for Producing a Packaged Batter

(76) Inventor: Kelly Beaulieu, Portage La Prairie (CA)

Correspondence Address: ADE & COMPANY INC., 2157 Henderson Highway, WINNIPEG, MB, R2G1P9, CA

(21) Appl. No.: 12/299,193

(22) PCT Filed: May 1, 2007
(86) PCT No.: PCT/CA07/00732

§ 371 Date: Oct. 31, 2008

Related U.S. Application Data
(60) Provisional application No. 60/796,554, filed on May 2, 2006.

(51) Int. Cl. A23L 3/28

(52) U.S. Cl. 426/248; 99/451

(57) ABSTRACT

A method of producing a packaged batter which does not require refrigeration and has a useful shelf life is disclosed. The method includes forming the batter by initially sterilizing flour and mixing it with other sterile ingredients. The batter is then sterilized by subsequent exposure to an ultraviolet sterilizing beam before packaging. The entire process is performed in a common sterile environment. A system for producing this batter is also disclosed.

### FIELD OF THE INVENTION

The present invention relates to a system and method for producing a packaged batter in which the batter is sterilised and maintained in a substantially sterilised condition during packaging.

### BACKGROUND

It is known that partially prepared food products are desirable to consumers to save time and effort in preparing various foods. Partially prepared food products which are already known include dry cake mixes, dry pancake mixes and the like which only require the addition of water, milk or eggs. In each instance of a prepared batter mix however an additional step of providing wet ingredients is required. Some attempts have been made to provide fully mixed batter in cartons, however sterilizing the batter by traditional methods used for juice packaged in cartons and the like adversely affects the batter, for example by partially cooking the batter. Accordingly known mixed batters available in cartons still require refrigeration just as the individual ingredients (milk, eggs, butter) would. Known pre-mixed batters therefore are not as convenient as would be desired.

### SUMMARY OF THE INVENTION

According to one aspect of the invention there is provided a method for producing a packaged batter, the method comprising:

providing a flour product;

arranging the flour product to comprise a denatured flour having a gluten content which is substantially denatured;

sterilising the denatured flour to produce a sterilised flour by forming a slurry with the denatured flour and treating the slurry with an ultra high temperature sterilising treatment;

mixing the sterilised flour with additional sterile ingredients to form a batter;

producing a flow of the mixed batter;

directing an ultraviolet sterilising beam at the flow of the mixed batter;

collecting the batter subsequent to exposure of the batter to the ultraviolet sterilising beam; and

dispensing the collected batter into a package and sealing the package in a common sterile environment.

According to a second aspect of the present invention there is provided a system for producing a packaged batter, the system comprising:

a mixer for mixing flour with additional ingredients to form a batter and for producing a flow of batter;

a sterilising mechanism for directing an ultraviolet sterilising beam at the flow of batter;

a collector for collecting the flow of batter subsequent to exposure of the batter to the ultraviolet sterilising beam;

a dispenser for dispensing the collected batter into a package; and

a sealer for sealing the package;

the sterilising mechanism, the dispenser and the sealer being located in a common sterile environment.

The combination of pre-treated flour, a cold UV sterilizer and a sterile packaging environment allows a packaged batter to be sterilized and maintained in a sterilized condition so that the resulting packaged product has a useful shelf life without refrigeration.

All steps of the method are preferably executed within a common sterile environment.

The flow of batter is preferably produced by spraying the batter in an atomized spray in which the ultraviolet sterilizing beam is preferably directed at the atomized spray.

The ultraviolet sterilizing beam is preferably directed at the batter in a pulsed beam from opposing directions.

The flour may be mixed with the additional ingredients as the ingredients are sprayed in the atomized spray. In addition, the method may include removing flour lumps in the batter prior to producing the flow of the mixed batter.

The atomized spray may be arranged to comprise a sheeted pattern of batter, or a hollow cone pattern of batter using jets of high pressure gas.

When the flow of batter comprises an atomized spray of batter, the method may include refrigerating the batter as the atomized spray is formed.

Temperature of the batter may be maintained near, but is preferably refrigerated sufficiently below ambient room temperature throughout all steps of the method until packaging to inhibit bacteria growth. More particularly, the batter is preferably maintained at a refrigerated temperature less than ambient room temperature when the ultraviolet sterilizing beam is directed at the batter.

The flour product may be arranged to comprise a denatured flour, having a gluten content which is substantially denatured, by providing a flour product comprising a low micro-organism load flour. The low micro-organism load flour is typically produced by treating kernels with steam prior to milling the kernels into the flour product to both denature the gluten content and reduce the micro-organism load in the flour prior to a second sterilisation step to further reduce micro-organism load by ultra high temperature treatment of the flour and water slurry.

Some embodiments of the invention will now be described in conjunction with the accompanying drawings in which:

### BRIEF DESCRIPTION OF THE DRAWINGS

FIG. 1 is a schematic view of the system and method for producing a packaged batter according to the present invention.

FIG. 2 is a perspective view of a first embodiment of the atomizer.

FIG. 3 is a perspective view of a second embodiment of the atomizer.

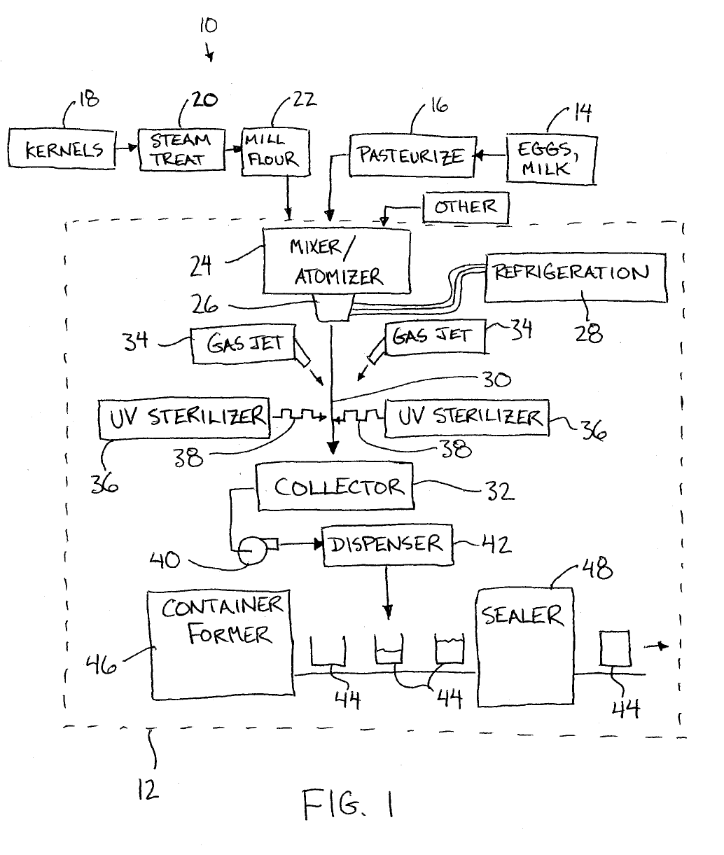

In the drawings like characters of reference indicate corresponding parts in the different figures.

### DETAILED DESCRIPTION

Referring to the accompanying figures there is illustrated a system for producing a packaged batter generally indicated by reference numeral 10. The system is particularly useful for producing a packaged batter in which the batter is sterilized and is maintained in a substantially sterilized condition during packaging.

The system 10 includes a sterile environment 12 where a substantial majority of the process is carried out. The ingredients of the batter are typically pre-treated at a separate location prior to their use in the sterile environment 12 within which the majority of the process according to the present invention is carried out. Fluid ingredients 14 including milk and eggs and the like are pasteurized 16 prior to being mixed with other ingredients to form the batter. The flour in the batter is also pre-treated by subjecting the kernels 18 to a steam treatment 20 prior to milling 22 so that the resulting flour comprises a low micro-organism load flour in which the micro-organism content has been substantially reduced as compared to conventional flour production and the gluten content of the flour is substantially denatured by the steam treatment. One system which is particularly suited for effective treatment of flour to be used in the method described herein is available by New Life Mills Limited of Hanover, Ontario, Canada. Other methods of pre-treating the flour include creating a flour/water slurry and exposing this mixture to a ultra high temperature treatment.

Prior to mixing with other ingredients, the flour is further sterilised in the common sterile environment by forming a slurry with the denatured flour and water and then treating the slurry with an ultra high temperature (UHT) sterilising treatment. The resulting denatured gluten in the flour, by providing a flour which has been pre-treated to have a low micro-organism load, is advantageous when forming a slurry with the flour as the slurry is more easily handled when using flour with a substantially denatured gluten content.

The system 10 includes a mixer 24 into which all of the pre-sterilized ingredients are fed. The mixer 24 comprises an atomizer which simultaneously mixes the ingredients into a batter and delivers the batter under a high pressure flow to an atomizer head 26 which produces an atomized spray of batter of sufficiently fine particles to remove any un-wetted flour lumps or pockets from the batter. A refrigerator 28, is coupled to the atomizer head 26 to cool the head and the batter being atomized therethrough to a temperature which is substantially less than ambient room temperature, for example in the order of 4° C. A suitable atomizer for use in the method described herein is available by Wilevco of Wilmington, Mass.

The atomized spray 30 is directed downwardly to a collector 32 by jets 34 of a high pressure gas which is substantially inert and non-reactive with the batter, for example nitrogen gas (N₂) or carbon dioxide (CO₂). The spray 30 is accordingly directed into a suitable pattern for maximizing the surface area thereof so that the batter can be effectively sterilized by ultraviolet radiation.

Ultraviolet sterilizers 36 are provided on opposing sides of the spray 30 of batter for directing ultraviolet beams 38 at the batter from a plurality of opposing directions. The beams 38 are emitted from the UV sterilizers 36 in a pulsed manner with sufficient strength to penetrate a substantially opaque batter but with the pulses of the beam being suitably controlled to prevent any heat accumulation in the batter. The batter is thus maintained in a substantially refrigerated condition below ambient room temperature as it is sprayed towards the collector 32. A suitable ultraviolet beam emitter for sterilising the batter according to the method described herein is available by Xenon Corporation of Wilmington, Mass.

The collector 32 feeds the sterilized batter to suitable pump 40 which pumps the sterilized batter under pressure to a dispenser 42 which meters portions of batter into respective containers 44. The containers 55 are formed by a container former 46 prior to being filled and sealed shut by a sealer 48 once filled. Sterilized dispensing and packaging equipment available by Tetra Pak™ and others is suitable for use with the present invention.

Throughout the process described herein, mixing, atomizing, sterilizing, collecting, dispensing and packaging of the batter is all maintained at a temperature substantially below ambient room temperature while all the steps of the process are also maintained in the sterile environment to ensure that the batter is maintained in a sterile condition once sterilized by the UV sterilizers 36.

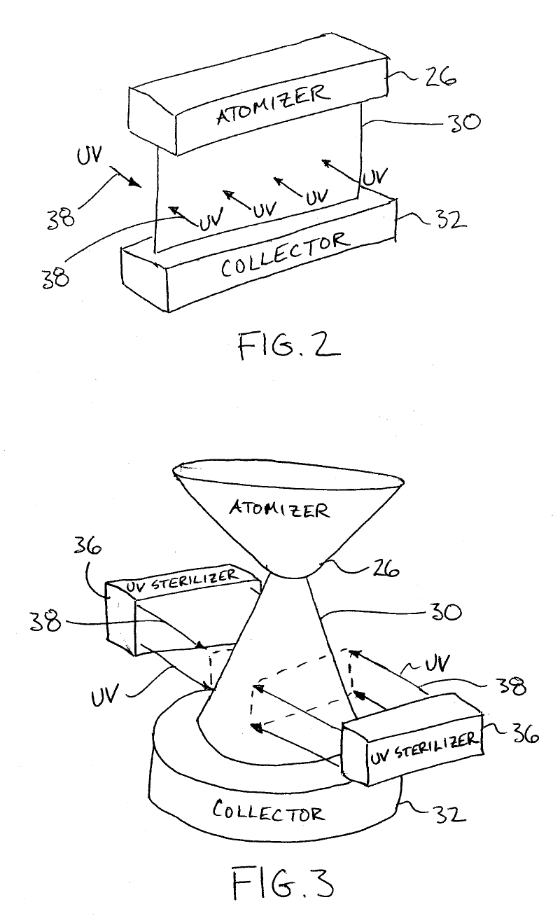

Turning now to FIG. 2, a first embodiment of the mixer/atomizer is illustrated in greater detail in which the atomized spray is directed as a flow into a generally planar sheet which is exposed to beams 38 from the ultraviolet sterilizers 36 from two opposing directions perpendicular to the sheet.

Alternatively as shown in FIG. 3, the spray 30 of atomized batter may be directed into a generally cone-shaped pattern which is hollow so that the batter again is in a very thin sheet with a maximum surface area. In this instance ultraviolet beams are provided from a plurality of opposing radial directions to ensure that the batter is fully radiated with ultraviolet light and that the light fully penetrates the batter.

In all embodiments, it is an object of the present invention to develop the necessary configuration of technologies to allow the aseptic packaging of pancake and cake batter into ready-to-use containers for the retail market.

As described above, a cold sterilization process has been developed to protect the integrity of the batter. In conjunction with the cold sterilization of the batter, a process to remove any unwetted flour lumps and to allow for the packaging of the product into shelf stable containers has also been developed. Once the product is sterile it can be packaged under high pressure and in a sterile nitrogen environment with the aseptic packaging system. Sterilization of the batter is accomplished with pulsed ultraviolet light combined with high pressure extrusion of the batter during the UV treatment.

As shown in the accompanying figures, two different batter extrusions methods may be used, including spray atomization or a flat fan: The flat fan of atomized batter or falling film pattern is the method required to create optimum surface area for light sterilization treatment. An extruder that produced a compact tent of liquid that could be exposed to the UV light on either side would likely produce the best results. The atomized batter can be moved into the tent formation using jets of pressurized gas.

All the ingredients of the batter are selected to be in the format that creates the lowest bacteria count. For instance: steam treated flour, pasteurized milk and eggs will be used in the process.

Steam treated flours have been designed for particular use as ingredients in the food manufacturing industry. Steam treated flours are produced from selected wheat varieties. The steam treatment process imparts specific functional characteristics which are not available from untreated flours, giving the following range of functional benefits: smooth, lump-free mixing with water, high water uptake, consistent flow characteristics with no gluten separation eliminating pump and filter blockage, no loss of viscosity during high speed mixing or pumping, consistent viscosity and ingredient pick up, no enzyme activity therefore no loss of viscosity on standing, no water separation on standing (no syneresis at ambient temperature), label declaration—‘Wheat Flour’, and significantly lower flour microbial load as compared to untreated flours. A flour/water slurry may also be used to further reduce the microbial load in the steam treated flour. This slurry would be subject to common ultra high temperature (UHT) treatments, cooled down and then used in the batter mixing process in an enclosed system or manner that protects the sterile nature of the flour slurry.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for producing a packaged batter, the method comprising:
providing a flour product;
arranging the flour product to comprise a denatured flour having a gluten content which is substantially denatured;
sterilising the denatured flour to produce a sterilised flour by forming a slurry with the denatured flour and treating the slurry with an ultra high temperature sterilising treatment;
mixing the sterilised flour with additional sterile ingredients to form a batter;
producing a flow of the mixed batter;
directing an ultraviolet sterilising beam at the flow of the mixed batter;
collecting the batter subsequent to exposure of the batter to the ultraviolet sterilising beam; and
dispensing the collected batter into a package and sealing the package in a common sterile environment.

2. The method according to claim 1 wherein all steps of the method are executed within a common sterile environment.

3. The method according to claim 1 wherein temperature of the batter is maintained near or below ambient room temperature throughout all steps of the method.

4. The method according to claim 1 including removing flour lumps in the batter prior to producing the flow of the mixed batter.

5. The method according to claim 1 including producing the flow by spraying the batter in an atomized spray.

6. The method according to claim 5 wherein the flour is mixed with the additional ingredients as the ingredients are sprayed in the atomized spray.

7. The method according to claim 5 including directing the ultraviolet sterilizing beam at the atomized spray.

8. The method according to claim 5 including producing the atomized spray to comprise a sheeted pattern of batter.

9. The method according to claim 5 including producing the atomized spray to comprise a hollow cone pattern of batter.

10. The method according to claim 5 including directing the atomized spray into a desired pattern by jets of high pressure gas.

11. The method according to claim 1 including maintaining the batter at a temperature less than ambient room temperature as the ultraviolet sterilizing beam is directed at the batter.

12. The method according to claim 1 wherein the flow of batter comprises an atomized spray of batter and wherein the method includes refrigerating the batter as the atomized spray is formed.

13. The method according to claim 1 including directing the ultraviolet sterilizing beam at the batter in a pulsed beam.

14. The method according to claim 1 including directing the ultraviolet sterilizing beam at the batter from opposing directions.

15. The method according to claim 1 including arranging the flour product to comprise a denatured flour having a gluten content which is substantially denatured by providing a flour product comprising a low micro-organism load flour by treating kernels with steam prior to milling the kernels into the flour product.

16. The method according to claim 1 including sterilizing the additional ingredients prior to mixing with the flour.

17. The method according to claim 16 wherein the additional ingredients include milk, and butter and wherein the method includes pasteurizing the milk and butter.

18. The method according to claim 16 wherein the additional ingredients include eggs and wherein the method includes pasteurizing the eggs.

19. A system for producing a packaged batter, the system comprising:
a mixer for mixing flour with additional ingredients to form a batter and for producing a flow of batter;
a sterilising mechanism for directing an ultraviolet sterilising beam at the flow of batter;
a collector for collecting the flow of batter subsequent to exposure of the batter to the ultraviolet sterilising beam;
a dispenser for dispensing the collected batter into a package; and
a sealer for sealing the package;
the sterilising mechanism, the dispenser and the sealer being located in a common sterile environment.

20. The system according to claim 19 wherein the system includes a refrigerator arranged to maintain temperature of the batter near or below ambient room temperature during mixing, sterilizing and dispensing the batter.
